(19) United States
(12) Patent Application Publication
(10) Pub. No.: US 2025/0278315 A1
(43) Pub. Date: Sep. 4, 2025

(54) APPLICATION PROGRAMMING INTERFACE (API) INTEGRATION LIBRARY

(71) Applicant: JP Morgan Chase Bank, N.A., New York, NY (US)

(72) Inventor: Sitalakshmi NARAYANAN, Singapore (SG)

(73) Assignee: JP Morgan Chase Bank, N.A., New York, NY (US)

(21) Appl. No.: 18/595,163

(22) Filed: Mar. 4, 2024

(51) Int. Cl. G06F 9/54; G06F 9/445

(52) U.S. Cl. CPC G06F 9/541; G06F 9/44505

(57) ABSTRACT

Various methods, apparatuses, systems, and media for implementing an application programming interface (API) integration library are disclosed. A receiver receives a user request of a process flow to access one or more resources. A processor creates a configuration file having a reusable and standardized format, wherein the configuration file includes detail data that specifies how the API connects to the one or more resources to execute the user request, how to create a standardized request, how to map a standardized response back in response to the user request, and how to handle retry attempts when the user request fails. The processor also causes a library to receive the configuration file as input that utilizes the configuration file to process the user request. The processor automatically creates, by the library, a desired application as output of the process flow based on the received configuration file.

### FIELD OF TECHNOLOGY

The present disclosure relates generally to Application Programming Interface (API) integration libraries and, in particular, to generating API integration libraries through configuration files.

### BACKGROUND

For any large platform, there is a requirement across ecosystems to communicate with services within or across ecosystems as well as other external systems. In this aspect, a service may be implemented by creating an application programming interface (API) that enables a user to access the service. Applications typically require infrastructure resources such as databases, message queues, etc. to function. Typically, these infrastructure resources need to be provided at the time of application startup. Modern applications may need to access a number of infrastructure resources to provide useful functionality. However, conventional techniques of coupling these infrastructure resources into a main application logic may prove to complicate architecture due to growing concerns with maintaining both the technical details such as resource availability/maintenance as well as business logic.

In general, API integration refers to the process of connecting two or more applications or systems by using APIs to exchange data and perform actions. APIs are sets of protocols and standards that allow different software applications to communicate with each other. APIs define how two applications share and modify each other's data. APIs are necessary in modern digital infrastructure because they enable standardized and efficient communication between applications which might differ in function and construction.

An API functions as an interface for programmers because the API is positioned between a software's core components and the public, and external developers can access certain parts of an application's backend without needing to understand how everything works inside the application. For instance, in an API use case for a financial transaction, a financial institution, such as a bank, can implement various APIs allowing third-party developers to access customer account information, payment processing, and transaction history. In financial transactions, the APIs allow different systems to communicate, but they also regulate what information can be shared. For example, the API connection between the third-party and the user's bank may give the third-party access only to six months of credit history, rather than access to all of the user's credit information.

In the financial transaction example, since the customer's bank is a different company from the third-party website that the customer is currently conducting the transaction on, an API facilitates interaction between the third-party website and the customer's bank. First, the third-party website uses the customer's bank gateway API to request the customer's banking information. Next, the customer's bank API fields the request, validates it, fetches the information from its customer database, and sends it back to the third-party website. Finally, the third-party website uses the customer's banking information to complete the transaction. The third-party website gets all the information it needs to complete the customer's transaction without having to access the customer's bank private database itself, and without requiring the customer to navigate off the third-party website.

There are several different types of APIs that serve different purposes and are designed for different use cases. Developers can work with an assortment of API types, protocols, and architectures that suit the unique needs of different applications and businesses. Some common API types by audience include public APIs, OpenAPI standard, private/internal APIs, and partner APIs. Example API types by architecture include monolithic APIs, microservices APIs, composite APIs, and unified APIs.

APIs exchange commands and data, and this requires clear protocols and architectures—the rules, structures, and constraints that govern an API's operation. When implementing programming interface integration between two parties using an API, API protocols, which are strict guidelines, are enforced to regulate interactions. The API protocols define how the API connects to the applications or systems and how it communicates information. The protocol chosen will determine how the developer designs and builds the API, as well as what is required to maintain it. These rules enhance efficiency when exchanging data within various applications through standardized communication modes.

Some requirements outlined by the API protocols include specifying formatting for request/response exchanges or permissible kinds of data that can be shared authentication procedures, or security measures for safe information transfer. Following these standards guarantees consistent interactions while ensuring reliable performance. Some of the major API protocols include the Representational State Transfer (REST or RESTful) protocol, the Simple Object Access Protocol (SOAP), the Remote Procedure Call (RPC) protocol, and the GraphQL protocol.

In addition, APIs utilize various request methods that define how a client application is allowed to interact with online systems. There are five popular kinds of API request methods: GET, POST, PUT, PATCH, and DELETE. The GET method retrieves information or data from a specified resource. The POST method submits data to be processed to a specified resource. The PUT method updates a specified method resource with new data. The PATCH method partially updates a specified resource. The DELETE method deletes a specified resource.

The developer of an API is typically required to ensure that the API conforms with industry standards and internal governance standards. The process of ensuring such conformance can be relatively time-consuming and expensive, especially insofar as it is performed on an individualized case-by-case basis. The application developer may need to write numerous amounts of application code to get the API working. Often, most of this application code may be repetitive, such as connecting to a database, making a REST API or SOAP call, sending a message via MQ (Message Queue) or other messaging platforms (e.g., Kafka), etc. In addition, connecting to these resources typically includes a very complex process and a major challenge in the development and maintenance (future enhancements) of an application.

Based on various business scenarios there is need for communication either by synchronous (SYNC) over APIs or asynchronous (ASYNC) over Kafka between the services or the systems. Given that each conventional service or system has its own request/response structure, and authentication mechanisms, each calling (consumer) system has a need to write code to create a request to the producer to extract data out of its data set, establish communication over a channel, retrieve a response back, and marshal it back to its data set. This is a common pattern across all services for the different APIs and the different use cases for the APIs.

Thus, there is a need for a platform that can communicate across its ecosystems and to external sources for various use cases for API connections. There is a need for an integrated development environment (IDE) that functions as an interface that provides developers with access to all the tools needed for the code development of an application within a single platform. Such a platform can be a time and cost saver for developers by using a reusable, ready-made engine that offers quick access to commonly used features which makes the development easy for developers of any skill level to use, including beginner developers.

### SUMMARY

The present disclosure, through one or more of its various aspects, embodiments, and/or specific features or sub-components, provides, inter alia, various systems, servers, devices, methods, media, programs, and platforms for implementing an API integration library into reusable application and infrastructure resources, but the disclosure is not limited thereto. For example, the various aspects, embodiments, features, and/or sub-components may also provide optimized processes of implementing the API integration library as a reusable component that helps configure request mapping, authentication, response mapping, retry configuration, and timeouts in a configuration file.

In various exemplary embodiments, the API integration library can abstract out any communication over to a library that can be configured to work based on a configuration file, such as a JavaScript Object Notation (JSON) configuration file. The API integration library provides a tool for separating each application component into a configuration file, which can be linked together by the API integration library to allow for consistent easy orchestration and passing of data through the components to output desired results. The components can be independently developed, rendered, built, tested, versioned, and published which makes application development easier.

The API integration library can generate a standardized data set for configuring the services and applications. The API integration library can provide a method of standardizing a set of APIs and protocols by separating the functionality typically associated with the services and applications. The separation and standardization of the functionality can be implemented using an abstract interface to expose the functionality of the components of the services and applications. The abstract interface can be used to configure the functions using abstract commands/operations to achieve the desired results. The abstract interface can provide an open, standardized manner of building services and applications. The abstract interface can abstract out and expose the specific functionality so that the services and applications can exploit the capabilities to implement the desired services. The abstract interface can convert the abstract rule representation into a concise set of commands and configuration information to download to the API integration library.

Since the disclosed process, according to the exemplary embodiments, is language agnostic, the API integration library allows minimal overhead for development teams and allows automated development and testing of an application without requiring them to write any code. The API integration library supports reusable modules so the required functionality can be embedded in any application in any language. The configuration files, according to exemplary embodiments, may be written using JSON, but the disclosure is not limited thereto. For example, the configuration files can easily be extended to other readable file formats such as XML, YAML, etc., or any other configuration-based languages.

According to an aspect of the present disclosure, a method for implementing an application programming interface (API) integration library by utilizing one or more processors and one or more memories is disclosed. The method may include: receiving a user request of a process flow to access one or more resources; and creating a configuration file having a reusable and standardized format, wherein the configuration file includes detailed data that specifies how the API connects to one or more resources to execute the user request, how to create a standardized request, how to map a standardized response back in response to the user request, and how to handle retry attempts when the user request fails; causing a library to receive the configuration file as input that utilizes the configuration file to process the user request; and automatically creating, by the library, a desired application as output of the process flow based on the received configuration file.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for the purpose of illustrating the embodiments and are not to be construed as limiting the disclosure. Given the following enabling description of the drawings, the novel aspects of the present disclosure should become evident to a person of ordinary skill in the relevant art(s).

FIG. 1 shows an exemplary system for implementing an application programming interface (API) integration library, according to an exemplary embodiment.

FIG. 2 illustrates an exemplary basic API information created by utilizing an API information module in accordance with an exemplary embodiment.

FIG. 3 illustrates an exemplary environment specific uniform resource library (URL) and connection information created by utilizing an environment specification module in accordance with an exemplary embodiment.

FIG. 4 illustrates an exemplary metadata file created using a request attribute mapping module, according to an exemplary embodiment.

FIG. 5 illustrates an exemplary metadata file created using a response attribute mapping module, according to an exemplary embodiment.

FIG. 6 illustrates an exemplary metadata file created using a retry configuration module, according to an exemplary embodiment.

FIG. 7 illustrates an exemplary API Call Configuration of a configuration specification, according to an exemplary embodiment.

FIG. 8 illustrates an exemplary Incoming Data Configuration of a configuration specification, according to an exemplary embodiment.

FIG. 9 illustrates an exemplary API Configuration of a configuration specification, according to an exemplary embodiment.

FIG. 10 illustrates an exemplary Synchronous (Sync) API Information of a configuration specification, according to an exemplary embodiment.

FIGS. 10A-10B illustrate an exemplary Synchronous (Sync) API Information of a configuration specification, according to an exemplary embodiment.

FIG. 11 illustrates an exemplary Asynchronous (ASync) API Information of a configuration specification, according to an exemplary embodiment.

FIG. 12 illustrates an exemplary Request Configuration of a configuration specification, according to an exemplary embodiment.

FIG. 13 illustrates an exemplary Response Configuration of a configuration specification, according to an exemplary embodiment.

FIG. 14 illustrates an exemplary Retry Configuration of a configuration specification, according to an exemplary embodiment.

FIG. 15 is a flowchart of an exemplary process for implementing an API integration library, according to an exemplary embodiment.

FIG. 16 is a flowchart of an exemplary process for implementing an API integration library, without dependencies, according to an exemplary embodiment.

FIGS. 17-19 illustrate exemplary metadata files of the configuration templates created by utilizing the API integration library, in accordance with an exemplary embodiment.

FIG. 20 illustrates an environment in which various embodiments can be implemented.

### DETAILED DESCRIPTION

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As described herein, various embodiments provide various systems, servers, devices, methods, media, programs, and platforms for implementing an API integration library into reusable application and infrastructure resources, but the disclosure is not limited thereto. For example, the various aspects, embodiments, features, and/or sub-components may also provide optimized processes of implementing the API integration library as a reusable component that helps configure request mapping, authentication, response mapping, retry configuration, and timeouts in a configuration file.

In various exemplary embodiments, the API integration library can abstract out any communication over to a library that can be configured to work based on a configuration file, such as a JSON configuration file. The API integration library provides a tool for separating each application component into a configuration file, which can be linked together by the API integration library to allow for consistent easy orchestration and passing of data through the components to output a desired result. The components can be independently developed, rendered, built, tested, versioned, and published which make application development easier.

The API integration library can generate a standardized data set for configuring the services and applications. The API integration library can provide a method of standardizing a set of APIs and protocols by separating the functionality typically associated with the services and applications. The separation and standardization of the functionality can be implemented using an abstract interface to expose the functionality of the components of the services and applications. The abstract interface can be used to configure the functions using abstract commands/operations to achieve the desired results. The abstract interface can provide an open, standardized manner of building services and applications. The abstract interface can abstract out and expose the specific functionality so that the services and applications can exploit the capabilities to implement the desired services. The abstract interface can convert the abstract rule representation into a concise set of commands and configuration information to download to the API integration library.

Since the disclosed process, according to the exemplary embodiments, is language agnostic, the API integration library allows minimal overhead for development teams and allows automated development and testing of an application without requiring to write any code. The API integration library supports reusable modules so the required functionality can be embedded in any application in any language. The configuration files, according to exemplary embodiments, may be written using JavaScript Object Notation (JSON), but the disclosure is not limited thereto. For example, the configuration files can easily be extended to other readable file formats such as XML, YAML, etc., or any other configuration based languages.

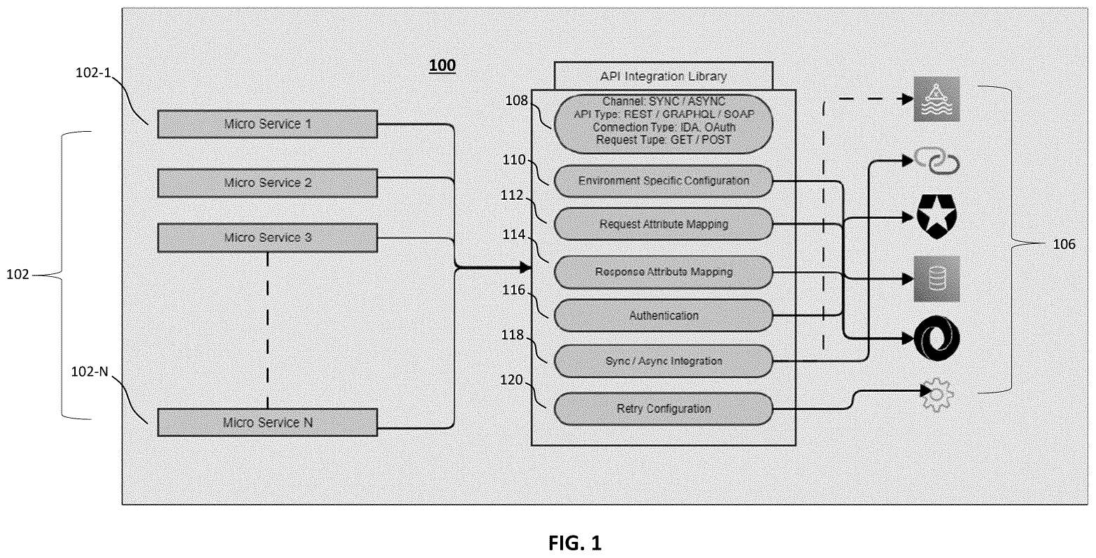

FIG. 1 is a block diagram of a system 100 for implementing an API integration library into reusable application and infrastructure resources. In various exemplary embodiments, the API integration library can be implemented as a reusable component that helps configure request mapping, authentication, response mapping, retry configuration, and timeouts in a configuration file.

FIG. 1 illustrates an exemplary use case of developing an application by utilizing an API integration library in accordance with an exemplary embodiment. As illustrated in FIG. 1, according to an exemplary use case, the system 100 may include one or more applications 102 operatively connected to infrastructure resources 106 at an endpoint through the use of an API integration library 104. FIG. 1 illustrates a representation of an API integration with one or more applications 102 connecting to infrastructure resources 106.

FIG. 1 depicts an example system 100 in which an embodiment of a method of automatically generating configuration files for different applications and generating templates that describe application layout and design. In such an embodiment, application 102 may include a monolith or microservices-based software application. FIG. 1 illustrates an example microservices-based architecture in implementations according to the present disclosure. Microservices architecture is a methodology that breaks up a software application into plural different services (e.g., microservices) that each perform a very specific process of the application.

In FIG. 1, one or more microservices 102 are deployed within the system 100. Depicted in FIG. 1 are N microservices identified using reference numerals 102-1 through 102-N (collectively, 102). Microservices 102-1 through 102-N are microservices that can work together to perform a specific application 102. Application 102 is split into a set of smaller interconnected microservices 102-1 through 102-N. Each of the microservices 102 can be created under a separate codebase that can be managed by different development teams. The developers of the microservices 102 can specify an interface such as an application programming interface to allow access to the functionalities provided by each of the infrastructure resources 106.

For this disclosure, a “service” can be used interchangeably with “microservice” to describe a software process, software application, application programming interface, and the like that provide functionalities such as communication and access to one or more computing resource, computing functionalities and or computing systems.

In an alternative embodiment, application 102 can be a monolithic architecture (not shown) in implementations according to the present disclosure. A monolithic application is traditionally built as a single unit. The monolithic application consists of a single self-contained unit in which code exists in a single codebase and in which modules are interconnected. At deployment time, the entire codebase is deployed, and scaling is achieved by adding additional nodes.

Applications 102 require infrastructure resources 106 such as databases, message queues, etc. to function. Typically, these infrastructure resources 106 need to be provided at the time of application startup. Applications 102 may need to access a number of infrastructure resources 106 to provide useful functionality. The system 100 performs an API integration process of connecting different software applications 102 through their respective APIs using API library 104 to enable them to communicate and share data seamlessly with infrastructure resources 106.

In general, the APIs are sets of definitions, protocols, and commands that applications use to exchange data with each other. Each API exposes a number of services (or endpoints) for the application or service that sits behind it. Applications 102 can use those API endpoints to submit commands, communicate, and interact with functionalities and data of the applications of the infrastructure resources 106. This allows these applications to interact and share data and functionalities, thereby creating an integrated and cohesive digital environment. By facilitating the exchange of functionalities and data, developers can use APIs to create new applications and services, leveraging the capabilities of the existing infrastructure resources 106 without having to understand their complexities.

In the example shown in FIG. 1, applications 102 can access the infrastructure resources 106 via an API gateway. The API gateway functions as the entry point for applications 102 to access the functionalities and data of the applications of the infrastructure resources 106. The gateway can be configured to receive API calls to specific services or applications of the infrastructure resources 106. The API gateway may be configured to provide user authentication and/or access control functionalities to ensure that only authorized clients may access the services or applications. The gateway may further be configured to enable tracking of resources available to receive the request (e.g., API calls) and to perform routing functions of the request to available infrastructure resources 106.

The user can be a client that initiates an API request or a request that is automatically activated by an external event or notification from a service or application. The client can be triggered by a user clicking on a button, application, or service. When any one of the clients desire access to the functionalities provided by one or more of the applications or services, that client can communicate with one or more of the applications or services via the API gateway. The clients can include, for example, but are not limited to, desktop computers, laptop computers, mobile devices, and enterprise clients belonging to external systems. Examples of enterprise clients include, but are not limited to, web applications, call centers, or off-site branch offices. Communication with the API gateway 120 can be made using any suitable communication method such as wired or wireless communication over a public network such as the Internet or proprietary networks such as cellular data networks or virtual private networks.

In various embodiments, FIG. 1 illustrates coupling the infrastructure resources 106 into a main application logic while maintaining both the technical details such as resource availability/maintenance as well as business logic. In various embodiments, system 100 can separate the business logic from the application logic which makes it easier to create, maintain, and update an application. Essentially, business logic is the set of rules and regulations that govern a business, including policies such as pricing, discounts, inventory levels, and customer eligibility. In the context of software development, business logic is the code that implements these rules within a specific application. The purpose of business logic is to ensure that an application behaves in a manner consistent with the business rules and procedures that it is designed to support.

Application logic, on the other hand, is the code that implements the business logic within a specific application. The application logic is a layer built on top of the business logic and serves to implement specific use cases. The application logic is responsible for taking the back-end business logic input and turning it into the front-end output that the user experiences. Application logic contains all of the rules and processes that control how the user interacts with the data. The application logic is concerned with how the user interacts with the application, and it outlines a series of actions triggered by an event.

One of the benefits of system 100 in separating the business logic from the application logic is that changes can be made to the underlying rules and procedures without having to modify the application logic. Another benefit is that it's easier to reuse the business logic across multiple applications. By separating the business logic from the application logic, the API integration library 104 can be created including reusable components that can be used in different applications. This can save time and effort, as the developer does not have to rewrite the same business logic for each application. Although the business logic is separated from the application logic, system 100 is configured to ensure that the business logic and the application logic work together seamlessly.

In FIG. 1, the API integration library 104 functions as a reusable component that helps configure request mapping, authentication, response mapping, retry configuration, and timeouts in a configuration file. In various exemplary embodiments, the API integration library 104 can abstract out any communication over to a library that can be configured to work based on a configuration file, such as a JSON configuration file. The API integration library 104 provides a tool for separating each application component into a configuration file, which can be linked together by the API integration library to allow for consistent easy orchestration and passing of data through the components to output a desired result. The components can be independently developed, rendered, built, tested, versioned, and published which make application development easier.

The API integration library 104 can generate a standardized data set for configuring the services and applications. The API integration library 104 can include a collection of resources that is leveraged during software application development to implement the software application. The resources may include, for example, configuration data, documentation, help data, message templates, source code or pre-compiled functions and classes, values or type specifications. For instance, the API integration library 104 may include information data related to a plurality of resources, e.g., REST resource, Kafka resource, database resource, etc., but the disclosure is not limited thereto. For example, information data related to any number of other resources (microservices) may also be stored in the library. According to exemplary embodiments, each resource information may include metadata describing the resource.

The API integration library 104 supports reusable modules so the required functionality can be embedded in any application in any language. The API integration library 104 can expose the functions of the resource for reuse by multiple, unrelated, independent programs such that the programmer only needs to know the interface and not the internal details of the library. In various embodiments, the API integration library can be configured as a code generation library, which is a high-level API that can generate or transform byte code for Java.

The API integration library 104 may store one or more applications that can include executable instructions that, when executed cause the API integration library 104 to perform actions, such as transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) in the API integration library 104 may be operative in a cloud-based computing environment. The application(s) may be executed within or as virtual machine(s) or virtual server(s) that may be managed in a cloud-based computing environment. Also, the application(s), and even the API integration library 104 may be located in virtual server(s) running in a cloud-based computing environment rather than being tied to one or more specific physical network computing devices. Also, the application(s) may be running in one or more virtual machines (VMs) executing on the API integration library 104. Additionally, in one or more embodiments of this technology, virtual machine(s) running on the API integration library 104 may be managed or supervised by a hypervisor.

As will be described below, the system 100 may be configured to receive a user request of a process flow corresponding to develop, test, or manage a desired application 102 via a computing device; access a data source that stores ready to use modules written for corresponding application programming interface (API) for a plurality of infrastructure resources 106 to determine what resources are necessary to develop, test, or manage the desired application 102; create a configuration file based on the resources accessed from the data source that are determined to be necessary to develop, test, or manage the desired application.

The configuration file includes details regarding data that specifies the API to connect, how to create the request, how to map a response back to the request, and how to handle retries in terms of a failure; cause a library or platform to receive the configuration file as input that utilizes the configuration file to process the user request of the process flow corresponding to develop, test, or manage the desired application; and automatically create, by the library or platform, the desired application as output of the process flow based on the received configuration file.

According to exemplary embodiments, as illustrated in FIG. 1, the API integration library 104 may include API information module 108, environment specification module 110, request attribute mapping module 112, response attribute mapping module 114, authentication module 116, sync/async (synchronous/asynchronous) integration module 118 and retry configuration module 120. Each module of the API integration library 104 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each module of the API integration library 104 may be implemented by microprocessors or similar, and may be programmed using software (e.g., microcode) to perform various functions discussed herein and may optionally be driven by firmware and/or software. Alternatively, according to exemplary embodiments, each module of the API integration library 104 may be implemented by dedicated hardware, or as a combination of dedicated hardware to perform some functions and a processor (e.g., one or more programmed microprocessors and associated circuitry) to perform other functions.

According to exemplary embodiments, each module of the API integration library 104 may be called via corresponding API.

Referring to FIG. 1, according to an exemplary embodiment, the system 100 may be configured to receive a user request of a process flow corresponding to develop, test, or manage a desired application 102 from a user via a computing device.

The system 100 abstracts out any communication over to API integration library 104 which works based on configuration details. The configuration files, according to exemplary embodiments, may be written using JavaScript Object Notation (JSON), but the disclosure is not limited thereto. For example, the configuration files can easily be extended to other readable file formats such as XML, YAML, etc., or any other configuration based languages.

The user of the API integration library 104 can specify the communication details, for example, in a JSON configuration. A user interface may be provided to allow a user to enter configuration details via an API development portal. API integration details, generating client keys, and configuring access grants are offered via the API portal. These configuration details can include identification data such as the API information, environment specification, request attribute mapping, response attribute mapping, authentication, sync/async (synchronous/asynchronous) integration, and retry configuration.

In FIG. 1, the API information module 108 is configured to receive from the user via the API portal basic API information such as, for example, channel supported, sync API types supported, connection types supported and request type, but the disclosure is not limited thereto. In the exemplary embodiments, the API integration library 104 may support the following: channels including asynchronous and synchronous channels; API types including REST, SOAP, and GraphQL; and synchronous authentication mechanisms connection types such as identity and access (IDA), Janus, default, basic authorization, OAuth, and Pass_Through. During use, the system abstracts synchronous or asynchronous communication from the core functionality which enables the services to focus on the business logic rather than the API integration.

The API integration library 104 may currently support the following API request methods: GET, POST, PUT, PATCH, and DELETE, but the disclosure is not limited thereto. The GET method retrieves information or data from a specified resource. The POST method submits data to be processed to a specified resource. The PUT method updates a specified method resource with new data. The PATCH method partially updates a specified resource. The DELETE method deletes a specified resource.

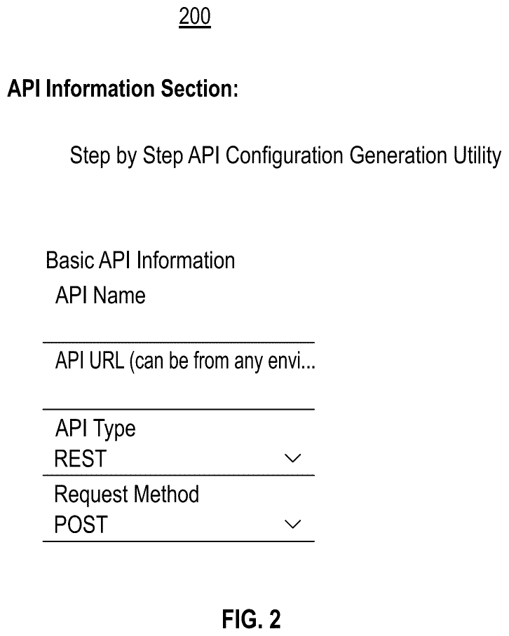

FIG. 2 illustrates an exemplary basic API information section 200 created by utilizing API information module 108 in accordance with an exemplary embodiment.

The environment specification module 110 is configured to receive from the user, via the API development portal, environment configuration details, which may include the environment specific URL and connection information. The user can define the specific environment in which one or more of the created applications are to be deployed. For example, applications created by the API integration library 104 that have been deployed within a specific environment may be accessible via an API gateway.

The environment that provides a runtime execution context for APIs. In various embodiments, a configuration table may be provided for managing the metadata of available applications at its runtime (e.g., application name for discovery, connectivity information, etc.) deployed in the specific environment for application API runtime discovery purposes, so that the API gateway can dispatch an API call to an appropriate resource.

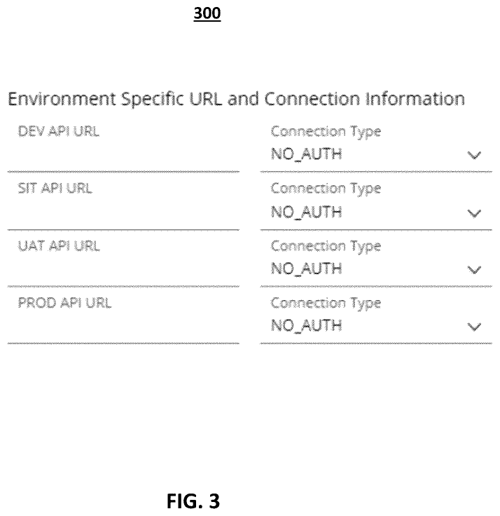

FIG. 3 illustrates an exemplary environment specific URL 300 and connection information created by utilizing environment specification module 110 in accordance with an exemplary embodiment.

In the example shown in FIG. 3, the URLs point to the specific environment. The example in FIG. 3 provides a multiple environment feature that enables the user to enter the environment configuration details to use different URLs for API calls on different environments. In FIG. 3, there are four environments which include development, testing, staging, and production, and four separate workspaces can be created for them. The development environment is the first environment in software development that serves as a workspace for developers to perform programming and other processes around software and/or system development.

The development environment is where changes to software code are made. The test environment is where the testing teams analyze the quality of the application/program. This also allows computer programmers to identify and fix any bugs that may impact smooth functioning of the application or impair user experience. The staging environment ensures that the software has been tested enough to be deployed in a production (PROD) or a User Acceptance Testing (UAT). The production environment is the last environment in software development where new builds/updates are moved into production for end users.

To use different URLs for API calls on each environment, the user can enter the environment configuration details to create separate workspaces for each environment and treat them as separate entities. In these workspaces, different data sources can be created with different URLs based on the environment settings.

In FIG. 3, the development workspace, the data source can be configured with the DEV API URL, whereas in the staging workspace, the data source can be configured with the SIT API URL. In the UAT workspace, the data source can be configured with the UAT API URL, and in the production workspace, the data source can be configured with the PROD API URL. This approach ensures that the API calls are made to the appropriate URL, based on the environment settings. This multiple environments feature can be used to achieve the desired functionality. Using multiple workspaces and configuring them with different data sources is a simple and effective way to implement different URLs for API calls in different environments.

In various embodiments, the API integration library 104 supports the ability to have different authentication mechanisms at every environment level. For example, the environment specification module 110 can be configured such that the dev URLs may not require any authentication, whereas the UAT and PROD may require connections to be authenticated over IDA.

In various embodiments according to the present teachings, the API integration library 104 can abstract out the authentication mechanism which requires the services to just add the authentication properties to the environment configuration of the environment specification module 110 and not worry about the communication.

In various embodiments, the system can be integrated with a unity-config-engine-library to abstract out the API configuration at the environment level. Namely, the API call configuration JSON with the configuration type (“ApiConfiguration”) and a configuration identification can be stored in a configuration table. Once stored in the configuration table, when a user, such as a developer of the application, through the use of a graphical user interface (“GUI”) can invoke the APIIntegrationStarterTemplate with the particular configuration identification and the input, the API integration library 104 will fetch the configuration JSON from the configuration table and perform the integration based on the configuration and send the response back to the caller.

In various embodiments, the API integration library 104 can be configured to abstract out the API invocation. The API invocation is used to invoke an API upon a client's request to access services. The API can be invoked when described in the sections of the code, such as the URL, specified in the application access key, Hypertext Transfer Protocol (HTTP) request body, and the API response HTTP status codes.

The API portal can be used to describe the rules that an API gateway applies to each API invocation. The gateway can provide the URL for an API, apply rules (sometimes also called policies) to the use of that API, and then direct the API call to the back-end implementation. Typically, the gateway can be given both the API specification and details of the rules it should apply. Thus, an API invocation via an API gateway can contain significantly more details and require careful parsing which can be implemented according to the features of the API integration library 104 as described herein.

During the API configuration generation, the API integration library 104 through the use of the request attribute mapping module 112 can create requests to services based on robust attribute mapping. Attribute mapping can be implemented to define which resource attributes map to the request. Attribute mapping determines how attributes of the request are transformed to match the requirement of the target resource. For each attribute of the request, each mapping entry can be examined to determine whether the attribute matches. Mapping is the process of relating parts of two existing data structures to one another. Typically, the result of the mapping process is a generated runtime code that transforms and moves data between mapped elements.

In the context of an example of a web service development, request attribute mapping is the mapping that is performed from an instance document that a web service receives to a high-level language data structure that web service uses in some way. Response attribute mapping is performed from a high-level language data structure that a web service acquires in some way to an instance document that the web service sends out.

According to exemplary embodiments as illustrated in FIG. 1, the request attribute mapping module 112 may be configured to manipulate the request with available values, such as parsing the data from input request into the specified modules; and allow value substitution into the dependencies.

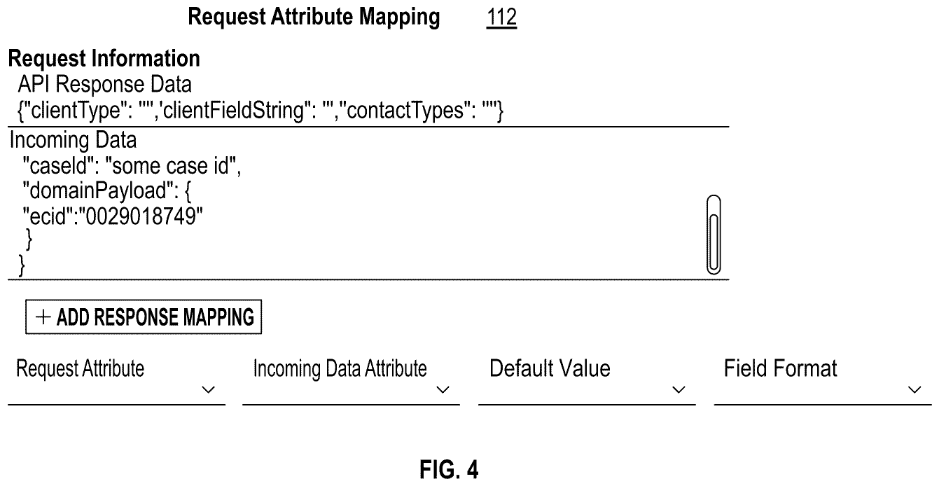

FIG. 4 illustrates an exemplary metadata file created using the request attribute mapping module 112 of FIG. 1.

In some embodiments, the request attribute mapping module 112 may be configured to include one or more additional features, such as incoming data translation as shown in FIG. 4. In such an embodiment, if the incoming data is a complex map and needs to be simplified for the request mapping, the incoming data translation can help perform this translation. If the incoming data is a complex structure—a nested map (map of map/list/primitive), the library has implementation to drill the data using JSON parsing to leaf nodes and use it for request mapping.

According to exemplary embodiments as illustrated in FIG. 1, response attribute mapping module 114 may be configured to re-arrange the output of a process in the desired manner, e.g., altering the output of a given resource.

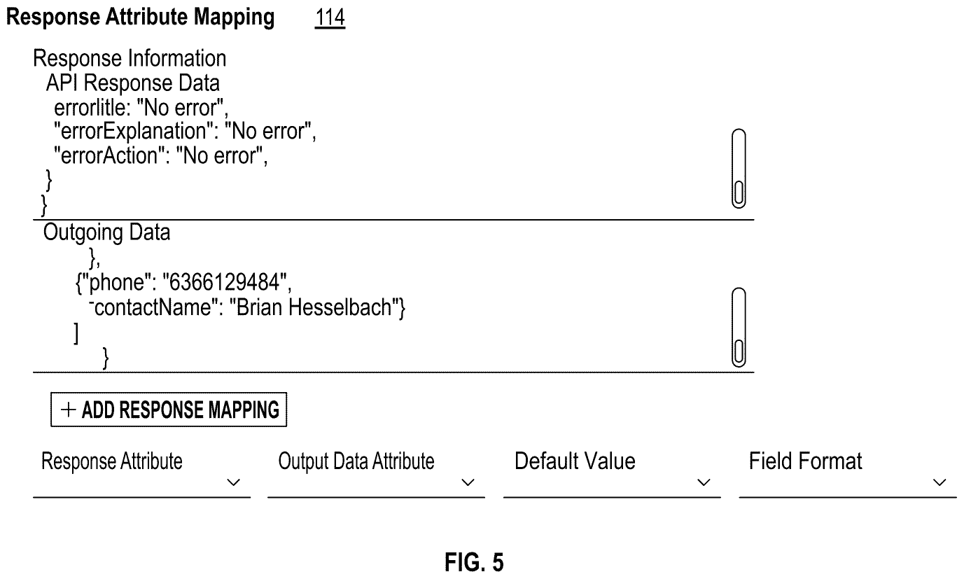

FIG. 5 illustrates an exemplary metadata file created using the response attribute mapping module 114 of FIG. 1.

In some embodiments, the response attribute mapping module 114 may be configured to include one or more additional features, such as response data translation as shown in FIG. 5. In such an embodiment, if the response (e.g., outgoing data) is a complex structure and if the service needs only a part or full transformation of the response, the response data translation can help to tailor select the response. If the data from the API has to be set to a complex structure (nested map of maps/list/primitive), the library has implementation to create a nested structure using JSON parsing and set the API response which then gets used by the consuming service.

As shown in FIG. 1, the API integration library 104 may also include an authentication module 116. Authentication module 116 may be configured to verify the identity of a user or application that is requesting access to an API and verify that the authenticated user or application has permission to access the requested resources. Authentication module 116 may authenticate a user or application during connection establish time. The API authentication module 116 may act as a “front door” for applications to access data, business logic, or functionality. An API gateway may be configured to provide user authentication and/or access control functionalities to ensure only authorized clients may access the services or applications.

According to the present teachings, the API authentication can be performed using various methods, for example, using synchronous authentication mechanisms connection types such as IDA, Janus, default, basic authorization, OAuth, and Pass_Through. The authentication module 116 ensures that only authorized users or applications are able to access the API and the resources it provides. This helps to protect sensitive data, user privacy and ensures compliance and that the API is used in a manner that is consistent with its intended purpose.

In FIG. 1, the API integration library 104 may further include a sync/async (synchronous/asynchronous) integration module 118. The sync/async integration module 118 may be configured to select a communication method that defines a sequence of operations to access or build services and applications in response to a request. For communications between a requestor and a service, there are two main communication models: a synchronous communication model and an asynchronous communication model.

In the synchronous communication model, a requestor communicates synchronously with a synchronous service. In other words, the requestor sends a request to the service and waits until a response is returned. The requestor is prevented from performing any other operations until the response is received. Synchronous communication is a single thread approach that follows a strict set of sequences, which means that operations are performed one at a time, in order. While one operation is being performed, other operations' instructions are blocked. The completion of the first task triggers the next, and so on.

In the asynchronous communication model, on the other hand, a requestor communicates asynchronously with a service. Namely, the requestor sends a request to the service, some time may pass, and a response is returned by the service. The requestor may perform other operations while waiting for the response from the service. Asynchronous communication is a multithread approach that allows multiple operations to be executed without blocking the main thread. The operations can be executed in any order or even simultaneously.

According to the present disclosure, there are some scenarios where one of the communication models is a better choice depending on the specific requirements of the task to be performed. Thus, the sync/async integration module 118 can be configured to evaluate the specific requirements of the request and choose the communication model method that best meets the requirements of the request. Some of the factors that may be considered in choosing the communication model method for a specific task include, for example, user experience, real-time applications, debugging, resource management, scalability, and background tasks.

In various embodiments, according to the present disclosure, the sync/async integration module 118 can be configured such that the communication model can be chosen to provide communication either by SYNC over APIs or ASYNC over Kafka between the services and/or systems.

In various embodiments, the system can be integrated with a unity-kafka-connector-library to support ASYNC communications.

In various embodiments, according to the present disclosure, the API integration library 104 is operable to abstract the SYNC or ASYNC communication from the core functional business logic code to enable the services to focus on the business logic rather than the API integration.

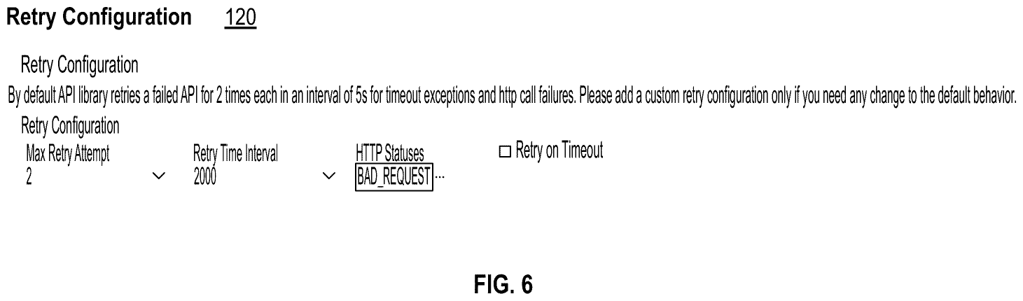

Referring to FIG. 1, the API integration library 104 may include a retry configuration module 120 that can be configured to support a retry based on HTTP statuses for a specified number of times over a specified interval. As illustrated in FIG. 6, in the retry configuration created using the retry configuration module 120, “retry”, as used herein, refers to a number that allows for the re-execution of the API in the event of a failure, until the specified threshold is reached. In various embodiments, the retry configuration module 120 can be configured to have the ability to specify read timeout and connection time out as illustrated in FIG. 6. In some embodiments, the retry configuration module 120 can be configured such that the system has the ability to retry when the external API connection fails.

According to the present disclosure, the API integration library 104 may provide one or more advantages, such as:
Written in Java;
Works based on a JSON configuration;
Abstracts SYNC/ASYNC communication from the core functionality which enables the services to focus on business logic rather than API Integration;
Creates requests to services based on robust attribute mapping;
Abstracts out the authentication mechanism which requires the services to just add the authentication properties to the environment configuration and not worry about the communication;
Abstracts out the API invocation;
Marshals the response sent by services to the required format based on attribute mapping;
Integrated with unity-kafka-connector-library to support ASYNC communication;
Integrated with unity-config-engine-library to abstract out API configuration at an environment level. Namely, the API call configuration JSON with the configuration type (“ApiConfiguration”) and a configuration identification can be stored in a configuration table. Once stored in the configuration table, when a user, such as a developer of the application, through the use of a graphical user interface (GUI) can invoke the APIIntegrationStarterTemplate with the particular configuration identification and the input, the API integration library 104 will fetch the configuration JSON from the configuration table and perform the integration based on the configuration and send the response back to the caller;
Supports the ability to have different authentication mechanisms at every environment level—for example, dev URLs may not require any authentication whereas UAT and PROD may require connections to be authenticated over IDA;
Supports retry based on HTTP statuses for a specified number of times over a specified interval; and
Supports the ability to specify read timeout and connection time out.

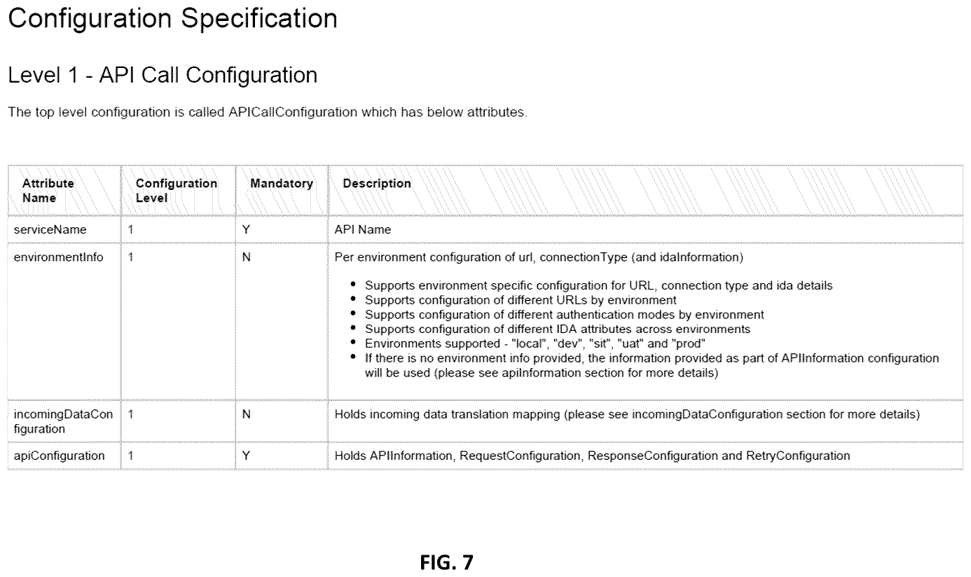

FIGS. 7-14 illustrate exemplary implementation of creating the configuration specification. In use, the API integration library 104 operates over a configuration which specifies the API to connect, how to create a request, how to map a response back, and how to handle retries in terms of failure. For each API connection, the user creates a configuration, such as a JSON configuration, (in this example, which can be called apiCallConfiguration) and stores it in the API integration library 104 along with the data to perform the integration.

As shown in FIGS. 7-14, the configuration specification can be created using multiple levels of detail. The hierarchy of the configuration specification may be defined as including, for example, three levels: level 1, level 2, and level 3. It should be understood that the levels 1-3 shown and described with reference to FIGS. 7-14 are nonlimiting and exemplary only. Those skilled in the art would understand that other configurations having more or less levels may be envisioned without departing from the scope of the present teachings.

At each level, the configuration specification can include one or more configuration tables containing data related to the configuration. The configuration tables can contain a plurality of fields including an attribute name, configuration level, mandatory designation and a description. It is understood that FIGS. 7-14 are exemplary and other embodiments of the configuration tables are not limited thereto.

In FIGS. 7-14, by using certain attributes to obtain information, the service requirements can be captured by the developer to create a content template that helps design the configuration specification of an application following industry standard specifications. The API configuration specification may be captured in a suitable API definition file format, such as JSON. The application requirements defined in the template become the input to the API integration library 104 for configuring and generating infrastructure capabilities and source code to be compiled and operated within the target deployment environment. A user interface may be provided within the development portal to allow a user to enter the application configuration details (e.g. the application requirements).

Given that the examples in FIGS. 7-14 are written in a JSON format, a tree representation of the configuration specification is created. In FIG. 7, Level 1, which is the API Call Configuration, is at the top level and is called APICallConfiguration and has the attributes shown.

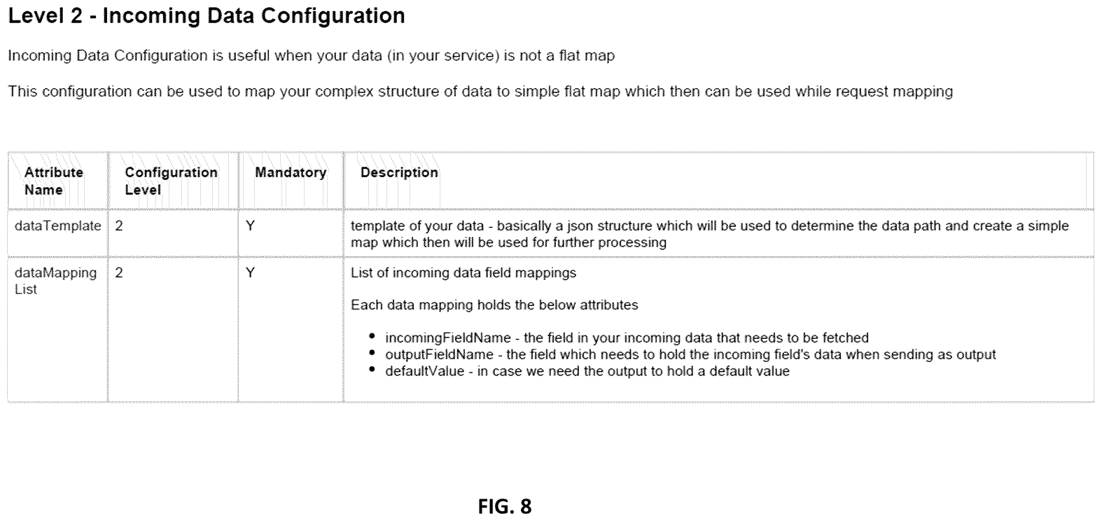

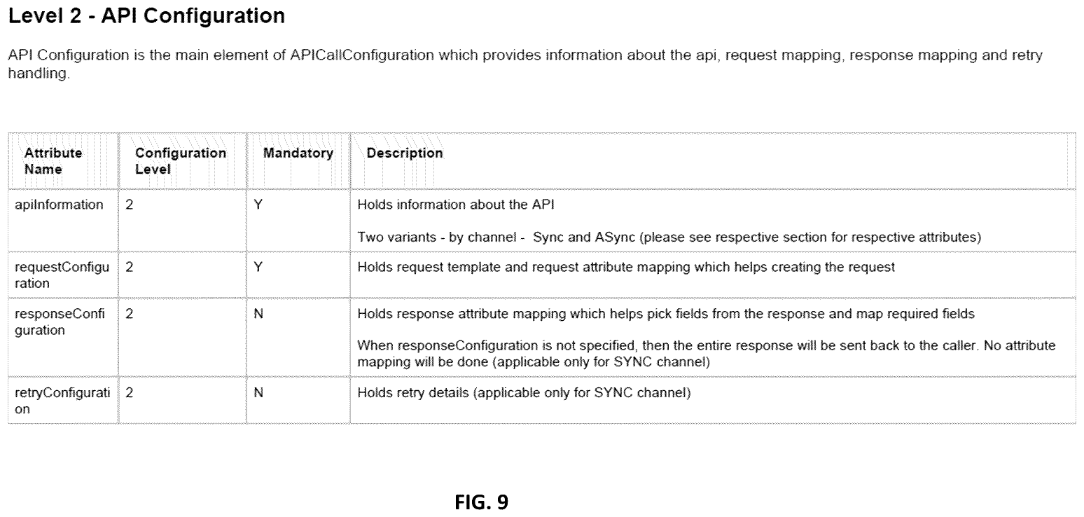

The configuration specification can be configured to construct the rest of the tree recursively based on the lower levels of the JSON format. Level 2 of the JSON configuration specification is shown in FIGS. 8-9. The Incoming Data Configuration, which is useful when the data in the service is not a flat map, is defined in FIG. 8. The Incoming Data Configuration can be used to map complex structure of the data to simple flat map which can then be used while conducting request mapping.

FIG. 9 illustrates the API Configuration, which is the main element of the APICallConfiguration and it provides information regarding the API, request mapping, response mapping and retry handling.

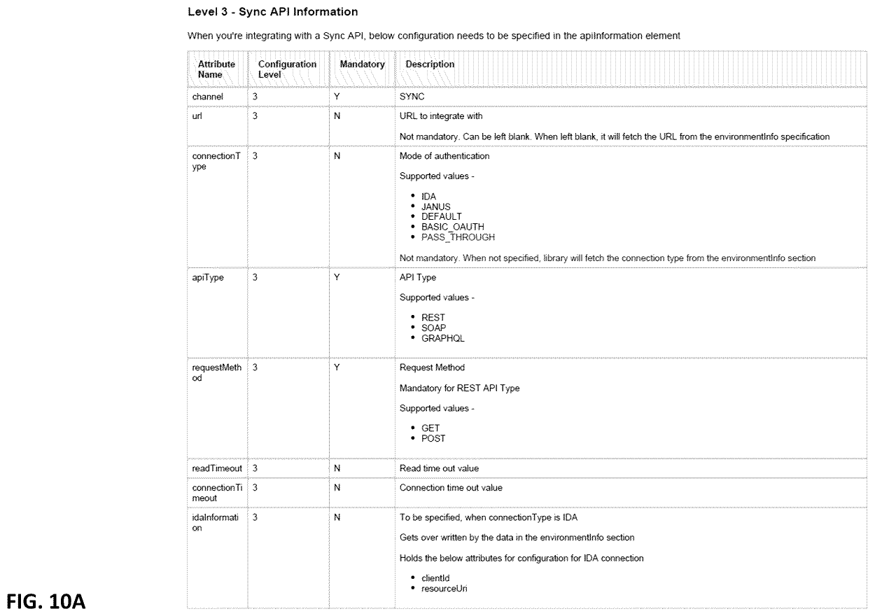

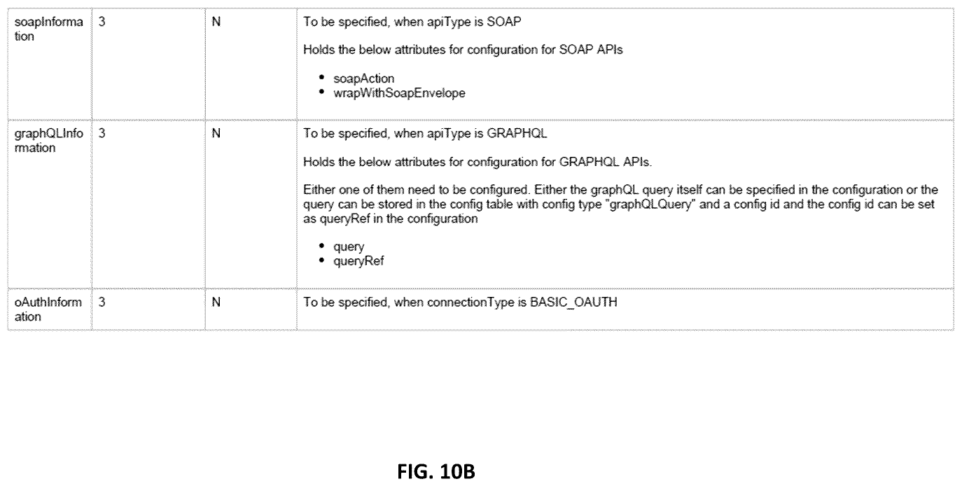

Level 3 is shown in FIGS. 10-14. FIGS. 10A-10B shows the details of the Sync API Information. When the client sends a request to integrate with a SYNC API, the configuration details shown in FIGS. 10A-10B need to be specified in the apinformation element.

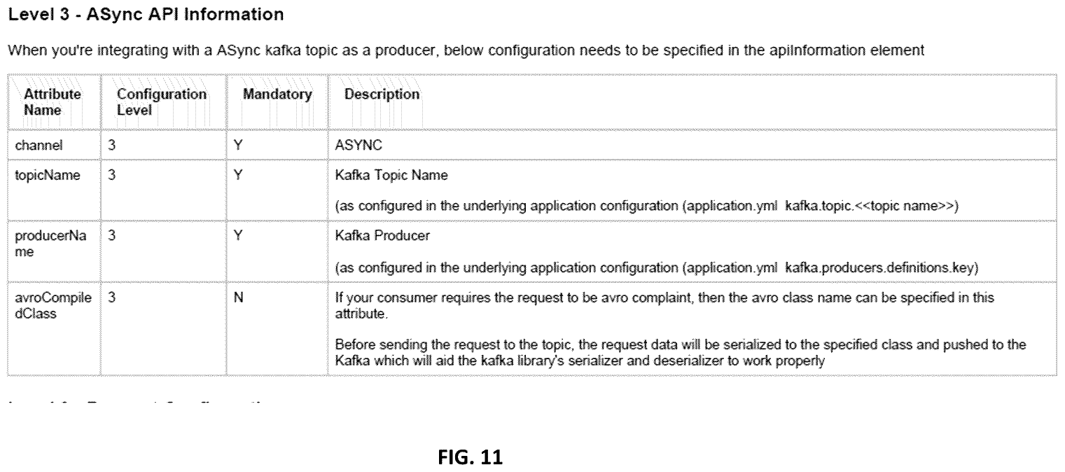

FIG. 11 shows the details of the ASYNC API Information. When the client sends a request to integrate with a ASYNC Kafka topic as a producer, the configuration details shown in FIG. 11 need to be specified in the apinformation element.

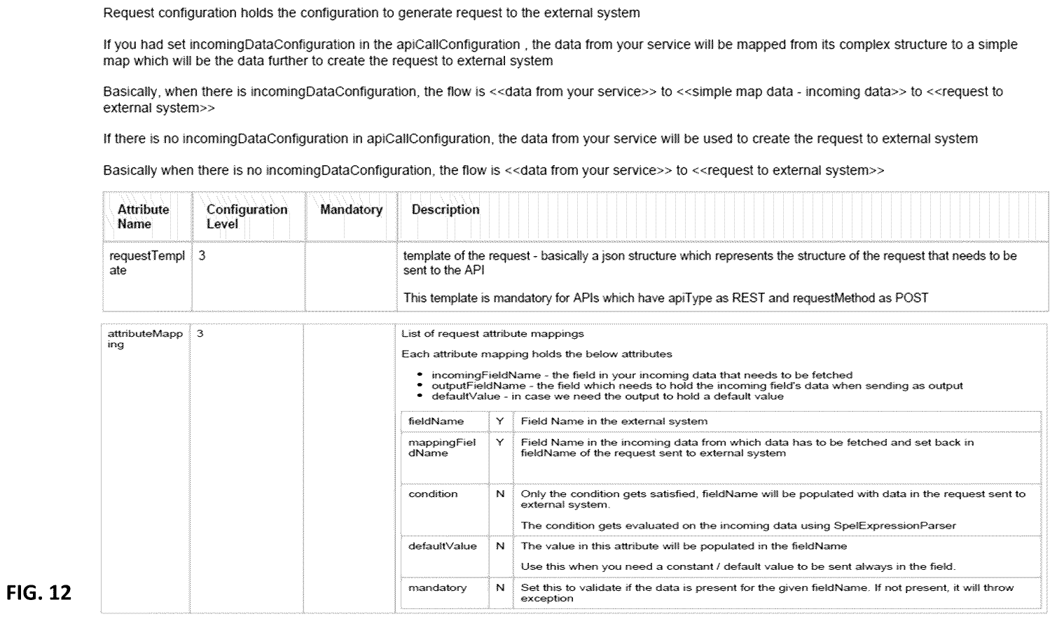

FIG. 12 illustrates the Request Configuration. The Request Configuration holds the configuration to generate a request to an external system.

If the user sets incomingDataConfiguration in the apiCallConfiguration, the data from the user's service will be mapped from its complex structure to a simple map which will be the data further used to create the request to the external system.

Basically, when there is incomingDataConfiguration, the flow is <<data from your service>> to <<simple map data—incoming data>> to <<request to external system>>.

If there is no incomingDataConfiguration in the apiCallConfiguration, the data from your service will be used to create the request to the external system.

Basically, when there is incomingDataConfiguration, the flow is <<data from your service>> to <<request to external system>>.

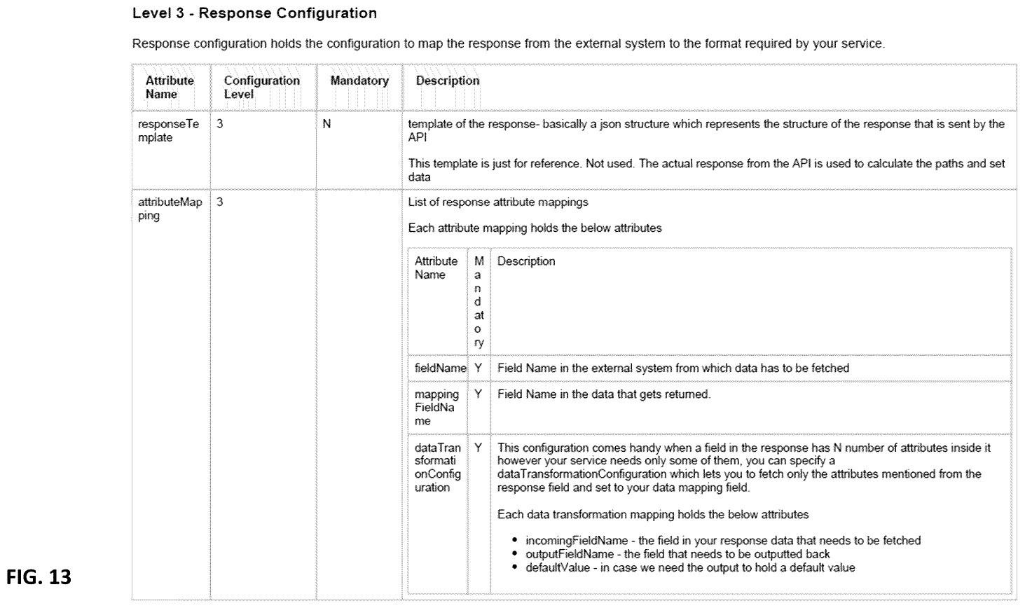

FIG. 13 shows the Response Configuration. The Response Configuration holds the configuration to map the response from the external system to the format required by the user's service.

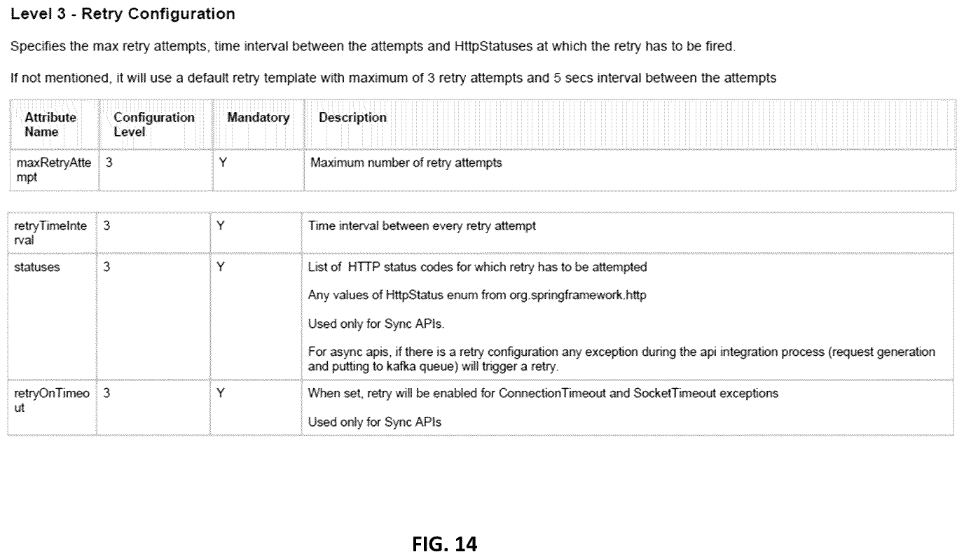

FIG. 14 illustrates the Retry Configuration which specifies the maximum retry attempts, the time interval between the attempts, and the HTTPStatuses at which the retry has to be fired. If the Retry Configuration is not mentioned, the system will use a default retry template with a maximum of three (3) retry attempts and a five (5) second interval between the attempts.

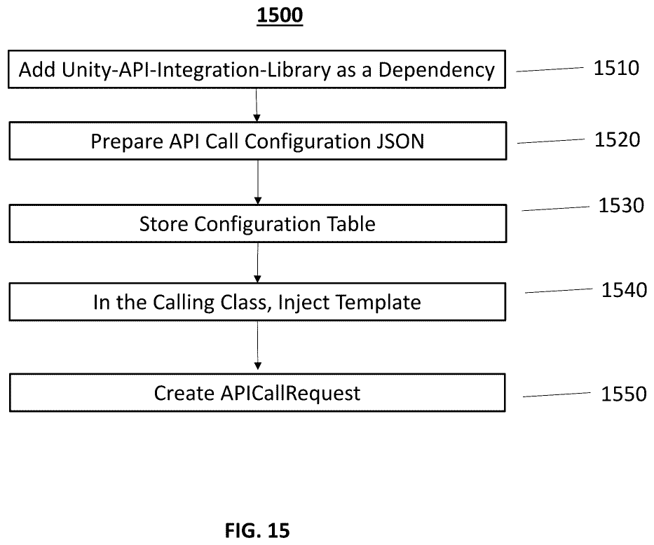

FIG. 15 illustrates a flow chart for implementing an API integration library to perform the API integration process 1500 in accordance with an exemplary embodiment.

As illustrated in FIG. 15, at block 1510, the process 1500 may include adding a unity-API-integration-library as a dependency in the user's pom.xml. The pom.xml is the project object model (POM) which is an extensive markup language (XML) file that contains information about the project and configuration details used to build the project.

At block 1520, the process 1500 may include preparing the API Call Configuration JSON.

At block 1530, the process 1500 may include storing the API Call Configuration JSON in the configuration table with the configuration type (config type) “ApiConfiguration” or any custom configuration type and a unique configuration identification (config id).

At block 1540, the process 1500 may include, in the calling class, injecting the configuration template “APIIntegrationStarterTemplate”.

At block 1550, the process 1500 may include creating the APICallRequest with the following information:
requestKey—key to identify the call. The requestKey is not mandatory. The requestKey can be used in ASYNC communications for sending as unique key to the Kafka message;
apiConfigurationId—configuration identification (config id) of the configuration stored in configuration table;
apiConfigurationType—if the API configuration is stored under a custom type (other than “ApiConfiguration”), leave the type field blank. The type field can be used to fetch the configuration JSON from the configuration table. If the type field is not specified, the process 1500 can use the “ApiConfiguration” as the configuration type (config type) for fetching the configuration; and
incomingData—input data from the user's service.

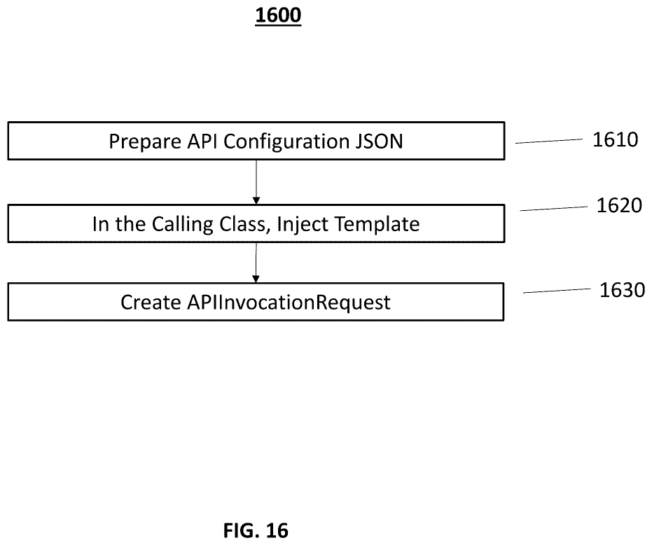

FIG. 16 illustrates a flow chart for implementing an API integration library without dependencies to perform the API integration process 1600 in accordance with an exemplary embodiment.

As illustrated in FIG. 16, at block 1610, the process 1600 may include preparing the API Configuration JSON (not call configuration) the Just apiConfiguration element of the APICallConfiguration.

At block 1620, the process 1600 may include, in the calling class, injecting the APIIntegrationTemplate.

At block 1630, the process 1600 may include creating APIInvocationRequest with the following information:
apiName—a name to identify the API;
requestKey—key to identify the call. The requestKey is not mandatory. The requestKey can be used in ASYNC communications for sending as a unique key to the Kafka message;
apiConfiguration—API Configuration; and
incomingData—input data from the user's service, which needs to be a map.

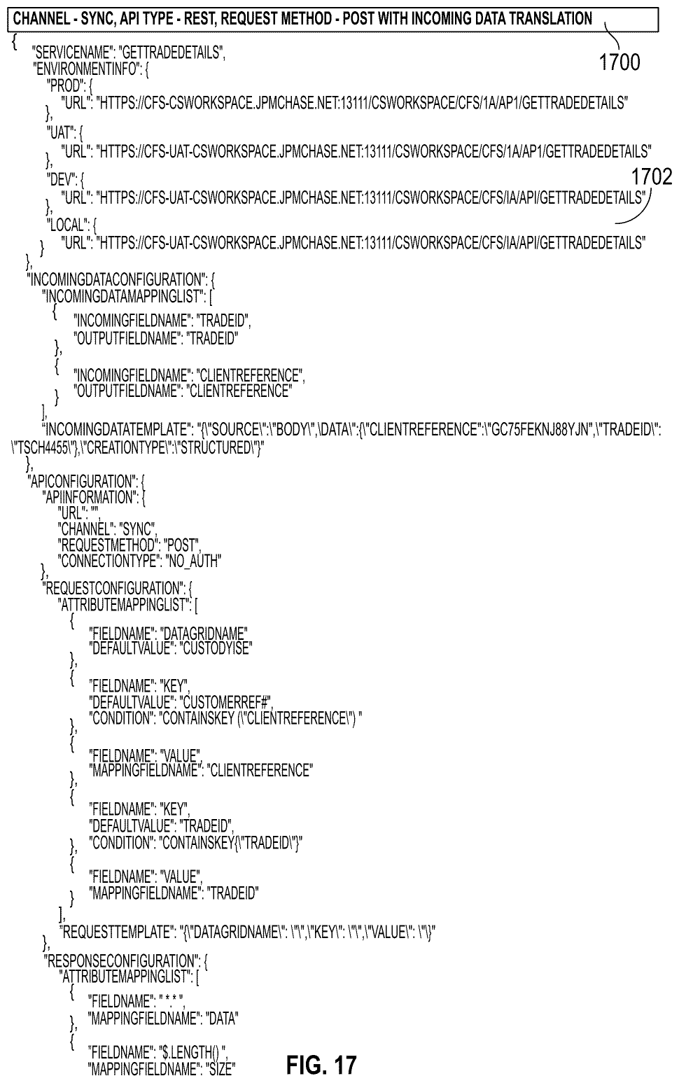

FIGS. 17-19 illustrate exemplary metadata files of the configuration templates created by utilizing the API integration library of FIG. 1 in accordance with exemplary embodiments.

As illustrated in the exemplary embodiment of FIG. 17, in the metadata file 1700 of the configuration template 1702, the user configures the Channel as a SYNC communication, the API Type as REST, and the Request Method as POST with incoming data translation.

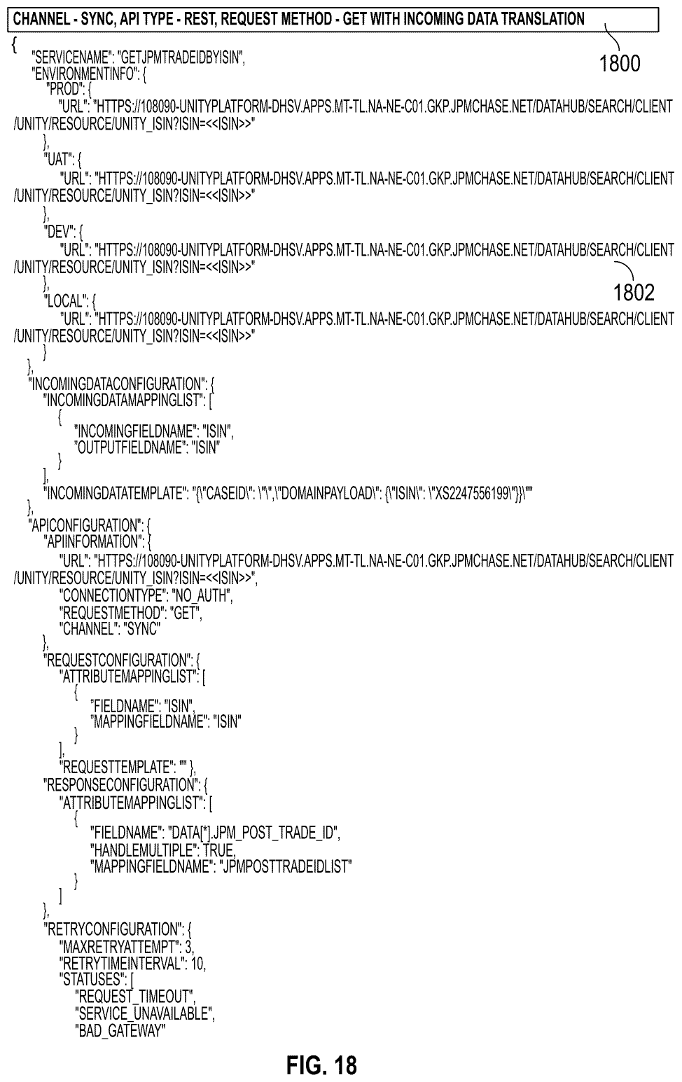

As illustrated in the exemplary embodiment of FIG. 18, in the metadata file 1800 of the configuration template 1802, the user configures the Channel as a SYNC communication, the API Type as REST, and the Request Method as GET with incoming data translation.

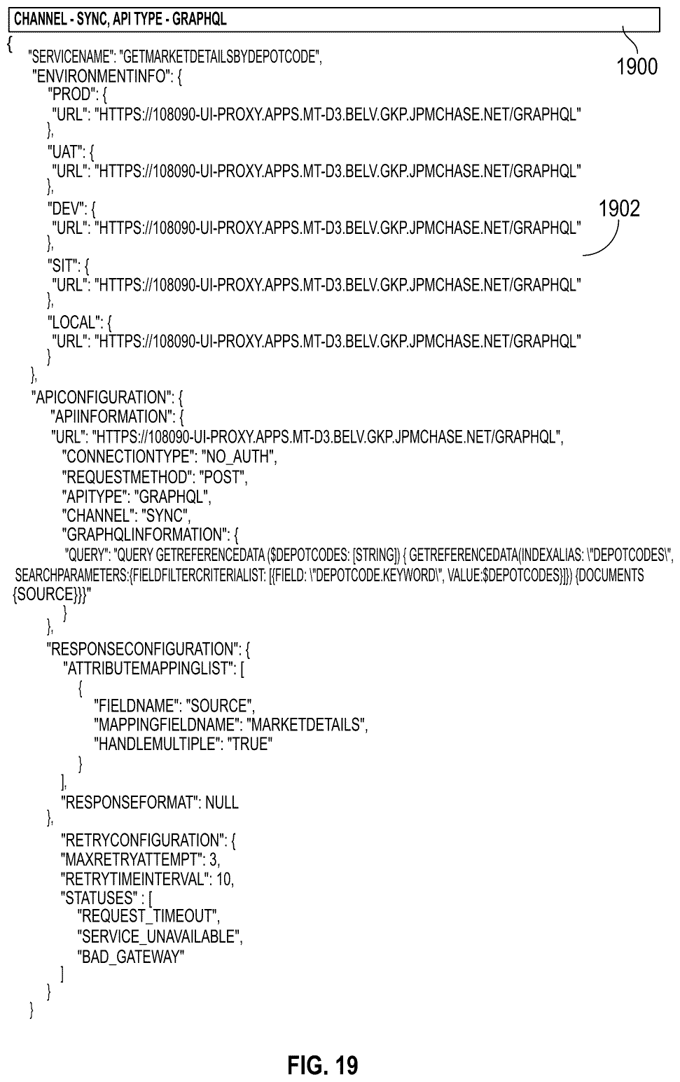

As illustrated in the exemplary embodiment of FIG. 19, in the metadata file 1900 of the configuration template 1902, the user configures the Channel as a SYNC communication, and the API Type as GRAPHQL.

According to various embodiments, there are some scenarios where special considerations need to be applied. One special consideration is when there is only Sync API Communication. If the user is using the API Integration Library only for Sync API integration and the user's service does not have Kafka configurations, the user should ensure that the application. yml has the following property: app.unity.kafka.enabled=false.

Another special consideration is when there is no dependency on the configuration table. If the user is using the API Integration Library to invoke Sync API/Async API directly without storing the configuration in configuration table and the user's service does not have cassandra dependency, then the user should ensure that the application startup has the following annotation:
@EnableAutoConfiguration (exclude=CassandraAutoConfiguration.class)

The following list provides several techniques that have been proposed for future applications of systems, devices, and methods according to the present disclosure.
1. User interface (UI) to build the API configuration JSON;
2. Async producer-Kafka configurations also to be part of the API configuration;
4. Support for byte array as a request as well as a response;
5. Send a default response in case of failure; and
6. Have default value configurations for response attribute mapping.

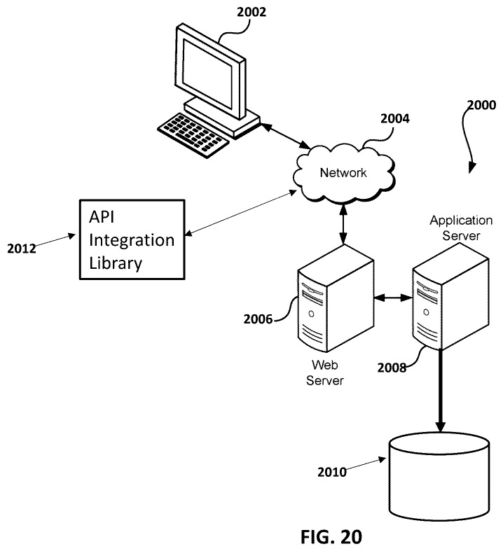

FIG. 20 illustrates aspects of an example environment 2000 for implementing aspects in accordance with various embodiments. Specifically, FIG. 20 illustrates a network diagram for implementing an API Integration Library in accordance with an embodiment. As illustrated in FIG. 20, the network 2000 may include an API Integration Library 2012, a server 2006, 2008, a database(s) 2010, one or more client devices 2002, and a communication network 2004.

According to exemplary embodiments, the API Integration Library 2012 may be connected to the server 2006, and the database(s) 2010 via the communication network 2004. The API Integration Library 2012 may also be connected to one or more client devices 2002 via the communication network 2004, but the disclosure is not limited thereto.

As will be appreciated, although a web-based environment is used for purposes of explanation, different environments may be used, as appropriate, to implement various embodiments. The environment includes a client device 2002, which can include any appropriate device operable to send and/or receive requests, messages, or information over an appropriate network 2004. In some embodiments, an appropriate device may convey information back to a user of the device. Examples of such client devices 2002 include personal computers, cell phones, handheld messaging devices, laptop computers, tablet computers, set-top boxes, personal data assistants, embedded computer systems, electronic book readers, and the like.

The network 2004 can include any appropriate network, including an intranet, the Internet, a cellular network, a local area network, a satellite network, or any other such network and/or combination thereof. Components used for such a system can depend at least in part upon the type of network and/or environment selected. Many protocols and components for communicating via such a network are well known and will not be discussed herein in detail.

Communication over the network can be enabled by wired or wireless connections and combinations thereof. In this example, the network 2004 includes the Internet and/or other publicly addressable communications network, as the environment includes a web server 2006 for receiving requests and serving content in response thereto, although for other networks an alternative device serving a similar purpose could be used as would be apparent to one of ordinary skill in the art.

The illustrative environment includes at least one application server 2008 and a data store 2010. It should be understood that there can be several application servers, layers, or other elements, processes, or components, that may be chained or otherwise configured, that can interact to perform tasks such as obtaining data from an appropriate data store.

Servers, as used herein, may be implemented in various ways, such as hardware devices or virtual computer systems. In some contexts, servers may refer to a programming module being executed on a computer system. As used herein, unless otherwise stated or clear from context, the term “datastore” or “data store” refers to any device or combination of devices capable of storing, accessing, and retrieving data, which may include any combination and number of data servers, databases, data storage devices, and data storage media, in any standard, distributed, virtual, or clustered environment.

The application server 2008 can include any appropriate hardware/software/firmware for integrating with the data store 2010 needed to execute aspects of applications for the client device 2002, handling some or all of the data access and logic for an application. The application server 2008 may provide access control services in cooperation with the data store 2010. It can also generate content including, but not limited to, text, graphics, audio, video, and/or other content usable to be provided to the user. Such content may be served to the user by the web server in the form of Hypertext Markup Language (“HTML”), Extensible Markup Language (“XML”), JavaScript, Cascading Style Sheets (“CSS”), JavaScript Object Notation (JSON), and/or another appropriate client-side structured language.

Content transferred to a client device 2002 may be processed by the client device 2002 to provide the content in one or more forms including, but not limited to, forms that are perceptible to the user audibly, visually, and/or through other senses. The handling of all requests and responses, as well as the delivery of content between the client device 2002 and the application server 2008, can be handled by the web server using PHP: Hypertext Preprocessor (“PHP”), Python, Ruby, Perl, Java, HTML, XML, JSON, and/or another appropriate server-side structured language in this example. Further, operations described herein as being performed by a single device may, unless otherwise clear from context, be performed collectively by multiple devices, which may form a distributed and/or virtual system.

The environment, in one embodiment, is a distributed and/or virtual computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 20. Thus, the depiction of the system illustrated in the example environment 2000 in FIG. 20 should be taken as being illustrative in nature and not limiting to the scope of the disclosure.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for implementing an application programming interface (API) integration library by utilizing one or more processors and one or more memories, the method comprising:
receiving a user request of a process flow to access one or more resources;
creating a configuration file having a reusable and standardized format, wherein the configuration file includes detail data that specifies how the API connects to the one or more resources to execute the user request, how to create a standardized request, how to map a standardized response back in response to the user request, and how to handle retry attempts when the user request fails;
causing a library to receive the configuration file as input that utilizes the configuration file to process the user request; and
automatically creating, by the library, a desired application as output of the process flow based on the received configuration file.

2. The method according to claim 1, further comprising: creating the configuration file in any one of the following file formats: index.JSON, index.xml, and index.yml.

3. The method according to claim 1, further comprising: abstracting out from the user request an API invocation.

4. The method according to claim 1, further comprising: implementing a request attribute mapper module configured to manipulate the received user request with available values.

5. The method according to claim 1, further comprising: implementing a response attribute mapper module configured to rearrange the output of the process flow in a desired manner.

6. The method according to claim 1, further comprising: implementing a retry configuration module configured to specify a read timeout and a connection time to handle the retry attempts when the user request fails.

7. The method according to claim 6, further comprising: implementing the retry configuration module configured to specify the retry attempts based on an HTTP status for a predetermined number of times over a predetermined time interval.

8. The method according to claim 1, further comprising: selectively accessing a communication model configured to define a sequence of operations for the user request based on requirements of the desired application.

9. The method according to claim 8, wherein the communication model is a synchronous communication model or a asynchronous communication model.

10. The method according to claim 1, further comprising: implementing an environment specific configuration module configured to define different authentication mechanisms at each environment level of the process flow.

11. The method according to claim 1, wherein the environment level is selected from a group consisting of: a development environment, a testing environment, a staging environment, and a production environment.

12. A system for implementing an application programming interface (API), the system comprising:
a receiver that receives a user request of a process flow to access one or more resources; and
a processor coupled to the receiver via a communication network, wherein the processor is configured to:
create a configuration file having a reusable and standardized format, wherein the configuration file includes detail data that specifies how the API connects to the one or more resources to execute the user request, how to create a standardized request, how to map a standardized response back in response to the user request, and how to handle retry attempts when the user request fails;
cause a library to receive the configuration file as input that utilizes the configuration file to process the user request; and
automatically create, by the library, a desired application as output of the process flow based on the received configuration file.

13. The system according to claim 12, wherein the processor is further configured to: create the configuration file in any one of the following file formats: index.JSON, index.xml, and index.yml.

14. The system according to claim 12, wherein the processor is further configured to: implement a retry configuration module configured to specify a read timeout and a connection time to handle the retry attempts when the user request fails.

15. The system according to claim 12, wherein the processor is further configured to: selectively access a communication model configured to define a sequence of operations for the user request based on requirements of the desired application.

16. The system according to claim 12, wherein the processor is further configured to:
implement an environment specific configuration module configured to define different authentication mechanisms at each environment level of the process flow.

17. A non-transitory computer readable medium configured to store instructions for implementing an application programming interface (API) integration library, wherein, when executed, the instructions cause a processor to perform the following:
receiving a user request of a process flow to access one or more resources;
creating a configuration file having a reusable and standardized format, wherein the configuration file includes detail data that specifies how the API connects to the one or more resources to execute the user request, how to create a standardized request, how to map a standardized response back in response to the user request, and how to handle retry attempts when the user request fails;
causing a library to receive the configuration file as input that utilizes the configuration file to process the user request; and
automatically creating, by the library, a desired application as output of the process flow based on the received configuration file.

18. The non-transitory computer readable medium according to claim 17, wherein, when executed, the instructions further cause the processor to perform the following: creating the index file in any one of the following file format: index.JSON, index.xml, and index.yml.

19. The non-transitory computer readable medium according to claim 17, wherein, when executed, the instructions further cause the processor to perform the following:
selectively accessing a communication model configured to define a sequence of operations for the user request based on requirements of the desired application and
wherein the communication model is a synchronous communication model or a asynchronous communication model.

20. The non-transitory computer readable medium according to claim 17, wherein, when executed, the instructions further cause the processor to perform the following:
separate a business logic from an application logic to create, maintain or update the desired application.
